(19) United States
(12) Patent Application Publication
(10) Pub. No.: US 2007/0016661 A1
(43) Pub. Date: Jan. 18, 2007

(54) Event organizer

(76) Inventor: Dale W. Malik, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/179,283

(22) Filed: Jul. 12, 2005

(51) Int. Cl. G06F 15/173

(52) U.S. Cl. 709/223

(57) ABSTRACT

Embodiments of the present disclosure provide systems and methods for preparing and organizing event materials. Briefly described, one embodiment can be implemented as follows. The system includes first logic configured to prompt a user to provide a first set of information; utilize the first set of information to prepare a first set of event materials for scheduling the event, prompt the user to provide a second set of information; utilize the first and second sets of information to prepare a second set of event materials for administering the event; prompt the user to provide a third set of information; and utilize the first, second, and third sets of information to prepare a third set of event materials for documenting the event. The system further includes second logic configured to associate materials prepared for the event with materials prepared for a related event. Other systems and methods are also provided.

### TECHNICAL FIELD

The present disclosure is generally related to management techniques and, more particularly, is related to techniques for organizing scheduled events.

### BACKGROUND

One obstacle in planning a meeting for a group of persons involves setting up a place and time for the meeting. Accordingly, there are a variety of software programs and computer applications that help a person plan and set up a meeting. These programs and applications, however, do not offer much utility to a meeting planner in managing items and events associated with the scheduled meeting. Similar problems are also evident with regard to scheduling other events, such as appointments, in general. Thus, a heretofore unaddressed need exists in the industry to address the aforementioned deficiencies and inadequacies.

### SUMMARY

Embodiments of the present disclosure provide systems and methods for preparing and organizing event materials, such as for a meeting. Briefly described, in architecture, one embodiment of a system, among others, can be implemented as follows. The system includes first logic configured to prompt a user to provide a first set of information; utilize the first set of information to prepare a first set of event materials for an event, where the first set of event materials includes event invitations for the event; electronically send the event invitations; prompt the user to provide a second set of information; utilize the first set of information and the second set of information to prepare a second set of event materials for administering the event; prompt the user to provide a third set of information; and utilize the first set of information, the second set of information, and the third set of information to prepare a third set of event materials which documents outcomes from the event. The system further includes second logic configured to associate materials prepared for the event with materials prepared for a related event, such as a meeting.

Embodiments of the present disclosure can also be viewed as providing methods for preparing and organizing event materials. In this regard, one embodiment of such a method, among others, can be broadly summarized by the following steps: prompting a user to provide a first set of information for an event; utilizing the first set of information to prepare a first set of event materials for the event, the first set of event materials including event invitations for the event; electronically sending the event invitations; prompting the user to provide a second set of information; utilizing the first set of information and the second set of information to prepare a second set of event materials for administering the event; prompting the user to provide a third set of information; and utilizing the first set of information, the second set of information, and the third set of information to prepare a third set of event materials which documents outcomes from the event.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing one embodiment, among others, of a system for managing meeting materials in accordance with the present disclosure.

FIG. 2 is a flowchart describing the functionality of a representative embodiment of the system of FIG. 1.

FIGS. 3-5 are diagrams illustrating one embodiment, among others, of a user interface for the meeting manager utilized in FIG. 1.

FIG. 6 is one example, among others, of a meeting invitation that is utilized in the system of FIG. 1.

FIGS. 7-18 are diagrams illustrating one embodiment, among others, of a user interface for the meeting manager utilized in FIG. 1.

FIG. 19 is a flowchart illustrating one embodiment, among others, of a process for preparing meeting materials in accordance with the system of FIG. 1.

FIG. 20 is a flowchart illustrating one embodiment, among others, of a process for preparing meeting materials in accordance with the system of FIG. 1.

FIG. 21 is a flowchart illustrating one embodiment, among others, of a process for preparing appointment materials in accordance with the system of FIG. 1.

### DETAILED DESCRIPTION

Reference is now made in detail to the description of the embodiments as illustrated in the drawings. While several embodiments are described in connection with these drawings, there is no intent to limit to the embodiment or embodiments disclosed herein. On the contrary, the intent is to cover all alternatives, modifications, and equivalents. While the description below refers to organizing materials for meetings for illustrative purposes, it should appreciated that the invention is also applicable to organizing any event, e.g., appointments.

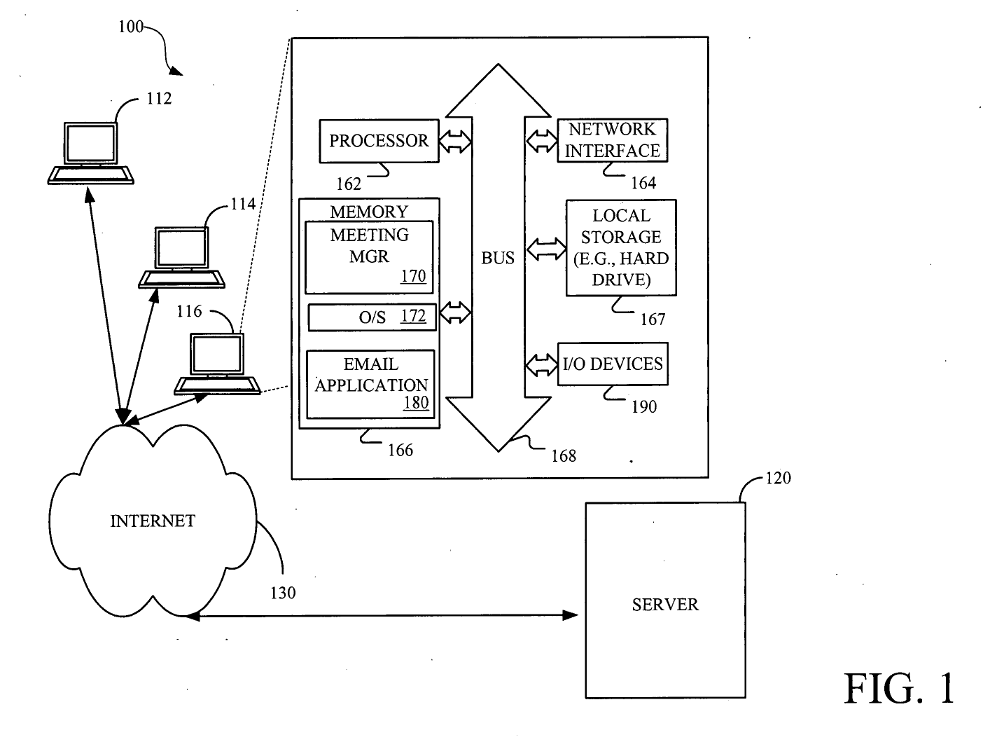

FIG. 1 is a block diagram showing one embodiment, among others, of a system for managing and organizing meeting materials. As shown in FIG. 1, one embodiment of the system comprises general-purpose computers 112, 114, 116 that are coupled to a server 120 over a network 130, such as the Internet, among others. In this embodiment, the communication network 130 provides access to Internet services such as email, File Transfer Protocol (FTP), World Wide Web (WWW), Internet Relay Chat (IRC), etc. and newsgroups, such as Usenet, via servers 120 on the network 130.

In the operating environment shown in FIG. 1, a user of a general-purpose computer 116 attempts to access applications on the computer 116 and services over the network 130. As shown in FIG. 1, the general-purpose computer 116 includes a processor 162, a network interface 164, memory 166, a local storage device 167, and a bus 168 that permits communication between the various components. While not explicitly shown, it should be appreciated that the other computers 112, 114 may also include similar components that facilitate computation or execution of applications on the computers 112, 114. In some embodiments, the local storage device 167 may be a hard drive configured to electronically store data. The local storage device 167 may also store computer programs that execute on the computer 116. In this sense, the processor 162 is configured to access any program or application, such as a meeting manager 170, that is stored on the local storage device 167 and execute the program with the assistance of memory 166.

The network interface 164 is configured to provide an interface between the general-purpose computer 116 and the network 130. Thus, the network interface 164 provides the interface for the computer 116 to receive data that may be entering from the network 130 and, also, to transmit data from the computer 116 to the network 130. Specifically, in some embodiments, the network interface 164 is configured to permit communication between each of the computers 112, 114, 116 and the server 120 and, additionally, to permit communication between the computers 112, 114, 116 themselves. In this regard, the network interface 164 may be a modem, a network card, or any other interface that communicatively couples each of the computers 112, 114, 116 to the network 130. Since various network interfaces are known in the art, further discussion of these components is omitted here.

In accordance with embodiments of the present disclosure, a meeting manager 170 is provided to facilitate preparation of meeting materials associated with a particular meeting. In some embodiments, a user may download the meeting manager 170 as a separate software module. However, in some embodiments, the meeting manager 170 may be integrated into other software applications such as an e-mail application 180 or other messaging applications. In other embodiments, the meeting manager 170, is provided via computer disks, computer cards, or other file-storage devices, or is pre-installed on the general-purpose computer 116. In the embodiment of FIG. 1, a meeting manager 170 is shown as being loaded into memory 166 for launching at the general-purpose computer 116, thereby permitting the meeting manager 170 to facilitate preparation of meeting materials on the general-purpose computer 116.

Memory 166 can include any one or combination of volatile memory elements (e.g., random access memory (RAM, such as DRAM, SRAM, etc.)) and nonvolatile memory elements (e.g., ROM, hard drive, tape, CDROM, etc.). Moreover, memory 166 may incorporate electronic, magnetic, optical, and/or other types of storage media. Note that memory 166 can have a distributed architecture, where various components are situated remote from one another, but can be accessed by the processor 162.

The software in memory 166 may include one or more separate programs, each of which comprises an ordered listing of executable instructions for implementing logical functions. In the example of FIG. 1, the software in memory 166 includes the meeting manager 170 and an operating system (O/S) 172. The operating system 172 essentially controls the execution of other computer programs, and provides scheduling, input-output control, file and data management, memory management, and communication control and related services.

The meeting manager 170 may be a source program, executable program (object code), script, or any other entity comprising a set of instructions to be performed. If the meeting manager 170 is a source program, then the program is translated via a compiler, assembler, interpreter, or the like, which may or may not be included within memory 166, so as to operate properly in connection with the O/S 172. Furthermore, the meeting manager 170 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The meeting manager 170 of the present embodiment can be implemented in software, firmware, hardware, or a combination thereof, etc. According to an exemplary embodiment, the meeting manager 170 is implemented in software, as an executable program, and is executed by a special or general-purpose digital computer 116, such as a personal computer, workstation, minicomputer, or mainframe computer.

According to an exemplary embodiment, the processes of the meeting manager 170 are activated or de-activated upon a manual command from a user. The meeting manager module 170 communicates with an e-mail application 180. As such, the meeting manager 170 may employ the e-mail application 180 to send e-mail communications. Further, the meeting manager 170 communicates with a calendar application (not shown). Accordingly, the meeting manager 170 may access a user's personal calendar via the calendar application (not shown). Also, the meeting manager 170 communicates with a database or other data storage logic maintained on a local storage device 167 that may be used to store meeting materials prepared by the meeting manager 170.

The software in memory 166 may further include a basic input output system (BIOS) (omitted for simplicity). The BIOS is a set of essential software routines that initialize and test hardware at startup, start the O/S 172, and support the transfer of data among the hardware devices. The BIOS is stored in ROM so that the BIOS can be executed when the computer 116 is activated.

I/O devices 190 may include input devices, for example but not limited to, a keyboard, mouse, scanner, digital camera, multi-function device, digital sender, microphone, etc. Furthermore, the I/O devices 190 may also include output devices, for example but not limited to, a printer, display, etc. Finally, the I/O devices 190 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When the meeting manager 170 is implemented in software, as is shown in FIG. 1, it should be noted that the meeting manager 170 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The meeting manager 170 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the meeting manager 170 is implemented in hardware, the meeting manager 170 may be implemented with any or a combination of the following technologies in a manner evident to one skilled in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

### II. Operation

Flowcharts are provided to show the functionality of representative implementations of the system 100 for managing and organizing meeting materials. It should be noted that in some alternative implementations, the functions noted in the various blocks may occur out of the order depicted in the flowcharts. For example, two blocks shown in succession in a flowchart diagram may, in fact, be executed substantially concurrently. Alternatively, the blocks may sometimes be executed in the reverse order depending upon the functionality involved.

According to an exemplary embodiment, the meeting manager 170 helps a user prepare materials involved in setting up a meeting; recording details of the meeting after the meeting has occurred; tracking action items from the meeting; planning future related meetings; and linking these new items or materials together in an organized and efficient fashion.

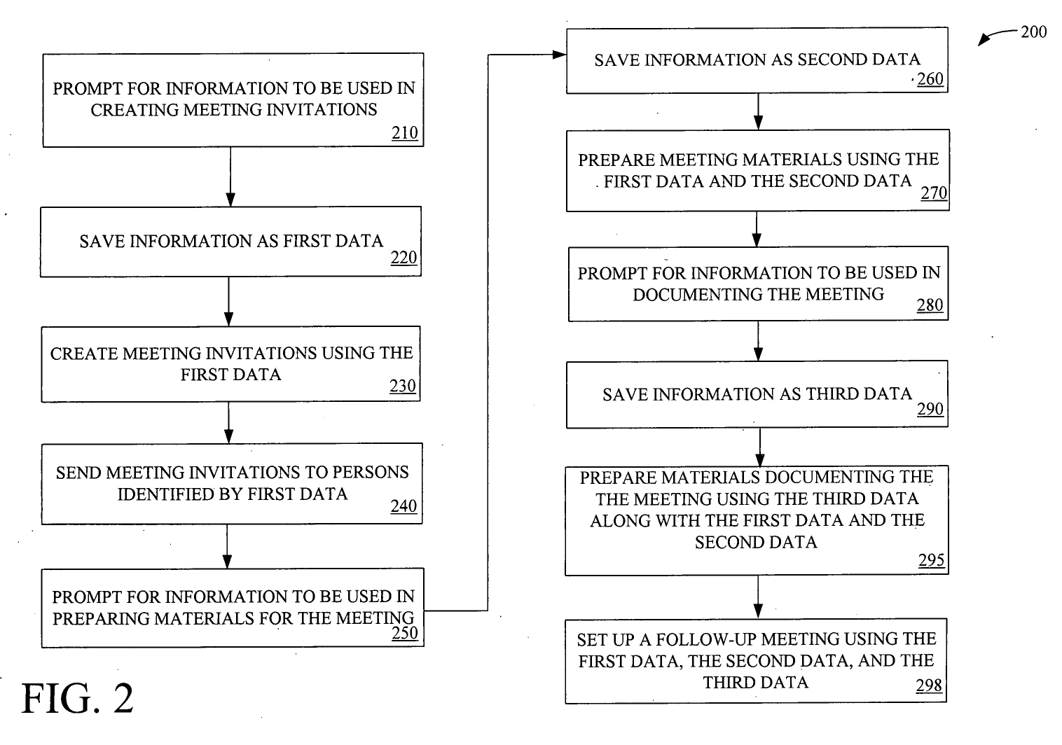

As depicted in the flowchart of FIG. 2, the functionality of a representative embodiment of the system 100 or method 200 for managing meeting materials may be construed as beginning at block 210. In this step, a user is prompted for information for creating invitations for attending a meeting. Then, the information provided by the user is saved (220) as a collection of data which may be referred to as first data. The first data is used (230) to create meeting invitations that are sent (240) to designated persons identified by the first data. Next, the user is prompted (250) for information for preparing materials for the meeting. The information provided by the user is then saved (260) as a collection of data which may be referred to as second data. The second data and the first data are used (270) to prepare materials (e.g., meeting agenda) that are used to facilitate the meeting. Then, after the meeting is held, the user is prompted (280) to provide information for documenting the happenings of the meeting, outcomes, results, decisions, planned future actions, etc. This information is saved (290) as a collection of data which may be referred as third data. The third data is used, along with the first data and the second data, to prepare materials documenting (295) the happenings of the meeting. Further, in some embodiments, the first, second, and/or third data are used (298) to set up a follow-up meeting.

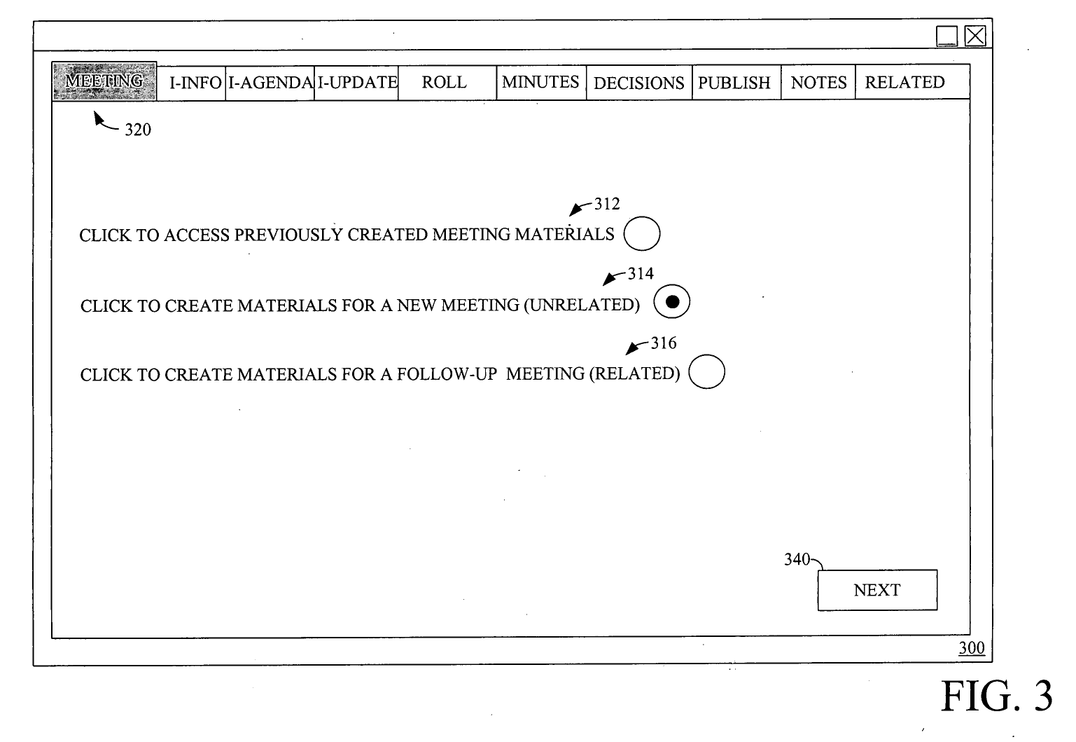

Next, FIG. 3 and accompanying figures show one embodiment, among others, of a user interface to the meeting manager 170 (“meeting manager interface”) for facilitating preparation of meeting materials. For example, after a user launches or activates operation of the meeting manager 170, a meeting manager interface 300, in FIG. 3, is shown, in some embodiments. The meeting manager interface 300 prompts a user to select one of three options. The first option 312 is for accessing previously created meeting materials. The second option 314 is for creating materials for a new meeting that have not been linked to previously created meeting materials. The third option 316 is for creating a follow-up meeting to a previous meeting, where previous meeting materials have been created and are stored in a database. The meeting manager interface 300 has a tab control 320 at the top of the interface 300 that identifies the particular interface screen being shown and being accessed by the user. Navigation of various interface screens may be facilitated by selecting the tabs associated with the interface screens. Upon selection of a particular tab, a screen of information associated with the screen is displayed within the meeting manager interface, for one embodiment. In other embodiments, different navigation schemes may be employed.

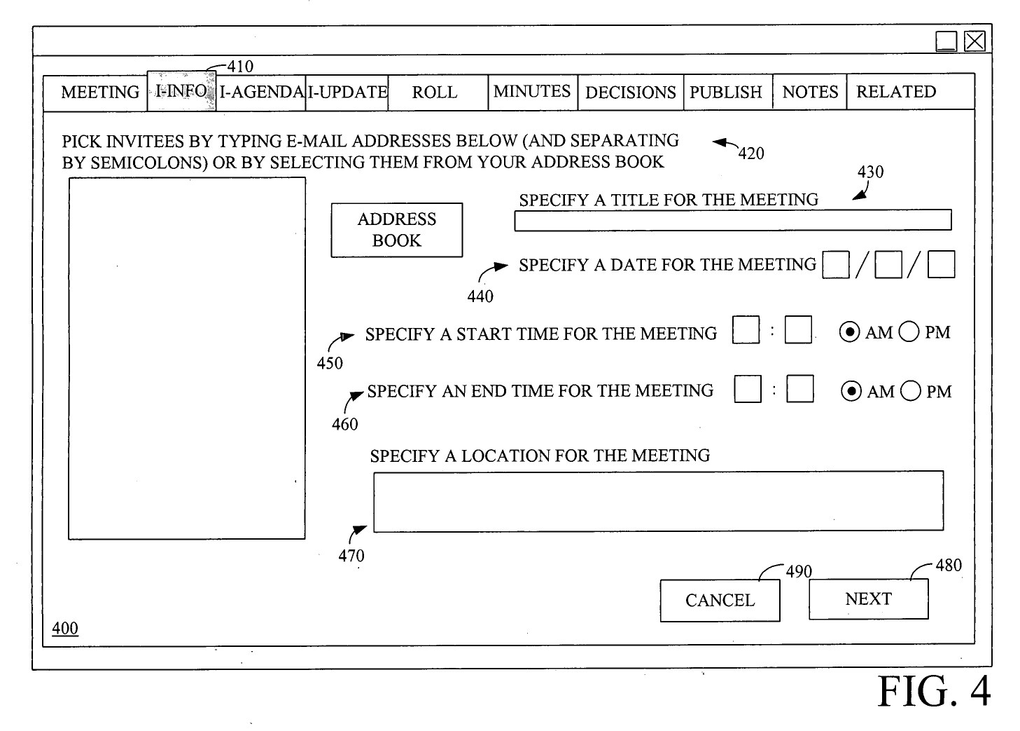

As an example, assume a user has selected the option of creating new meeting materials that has not been linked to previously created meeting materials, as shown in FIG. 3 (by clicking the radio button next to the second option 314). After selecting the Next button 340, the user is presented with a new interface screen 400 (as shown in FIG. 4) identified by the I-INFO tab 410 being highlighted. In this meeting manager interface screen 400, a user can provide information to assist in creating invitations to a new meeting. After selecting to create new meeting materials, the meeting manager 170 prompts the user to select persons for inviting to the meeting. As such, a user is prompted (as visually noted by pointer 420) to provide e-mail addresses of persons who are to receive meeting invitations. Further, in some embodiments, a user is prompted to reserve resources for the meeting, such as a conference room, audiovisual equipment, etc.

A user can type the email address manually or utilize an address book. As such, in some embodiments, the meeting manager 170 can access a user's electronic address book. Thus, in some embodiments, the meeting manager pulls names from a user's address book and provides these names for selection in a drop-down list. In other embodiments, other communications may be provided such as instant messaging addresses or voice mail numbers.

Alternatively, the meeting manager interface 400 may provide a place for the user to type in identification information of a person that the user would like to invite to the meeting. Along with identification information (such as a person's name), the meeting manager 170 may then prompt the user to provide an e-mail address (or other communication address, such as an instant messaging address, in some embodiments) if one is not retrievable from the address book of the user.

Additional information is also requested, such as a title for the meeting 430; a date for the meeting 440; a start time for the meeting 450; an end time for the meeting 460; and a location description for the meeting 470. Each of these items may be selected from or provided to the meeting manager interface 400.

After a user provides the requested information, or as much of the requested information as the user deems necessary, the user can progress to the next interface screen by selecting the Next button 480. Alternatively, the user can select the Cancel button 490 to leave the current interface screen.

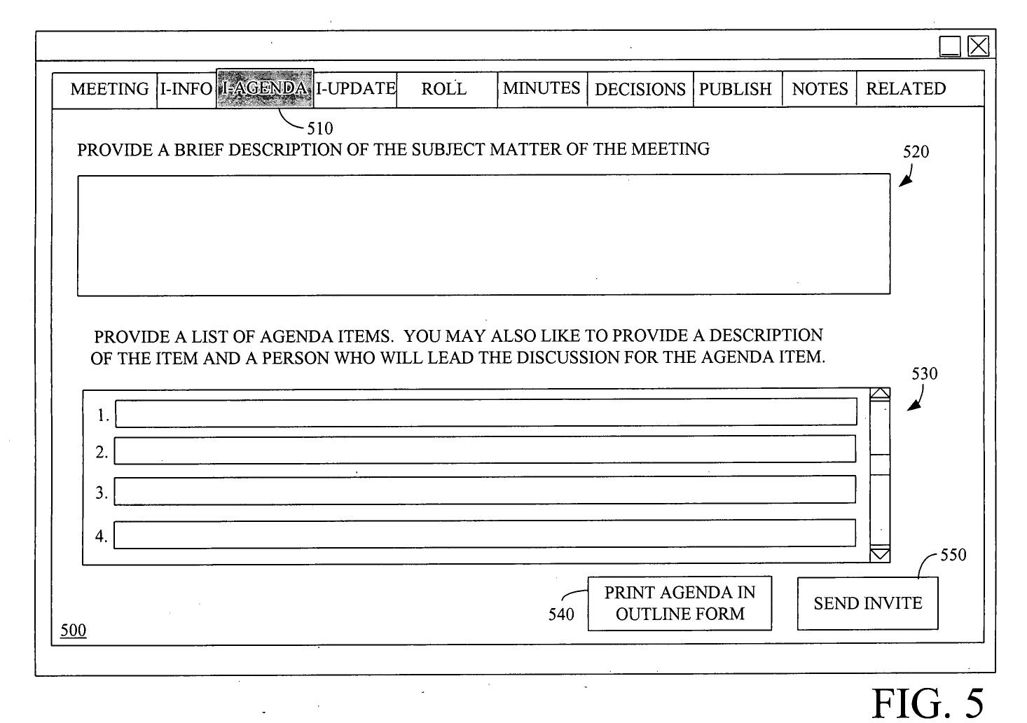

In the next interface screen 500 (as indicated by the highlighted I-AGENDA tab 510) in FIG. 5, the user is prompted for additional information, such as a short description of the subject matter or purpose of the meeting (as noted by pointer 520) and a list of agenda items that are to be discussed at the meeting (as noted by pointer 530). As an added option, after completing the agenda list, the user can print out a copy of the agenda for himself or herself by selecting the PRINT button 540. Thus, the user can use the printed agenda list to assist in running the meeting the user is planning. Further, after the user has provided the requested information for this screen and the previous screen, the user can send invitations to the meeting he or she has just planned by selecting the SEND INVITE button 550.

In some embodiments, an interface screen is provided that enables a user to specify an agenda item and then categorize the agenda item with regard to whether the item is expected to require additional actions. For example, if the agenda item indicates that an overview of a situation is to be presented, then the agenda item may be categorized as “information only,” such that additional actions or details are not expected to arise from presentation of the agenda item. Alternatively, if an agenda item is expected to result in a decision regarding the agenda item from the meeting, then the agenda item may be marked or categorized as “provide additional details,” such that a user is prompted to provide additional details regarding the agenda item after the meeting is held. Thus, different embodiments may employ different categories for agenda items.

For example, some embodiments may categorize an agenda item as “provide follow up action items and details” if presentation of an agenda item is expected to produce action items related to the agenda item in order to resolve the topic of the agenda item. Details of action items that may be provided with regard to an agenda item include a description of an action item that was produced from presentation of the agenda item, identification of person assigned to an action item, information regarding a follow-up meeting to discuss the agenda item, etc. Further, in some embodiments, information and action items that are provided for and result from an agenda item may be related to the agenda item within an organizational structure such that a user can track activities that arose from the agenda item. For example, the outcomes of meetings that arose from the meeting where the agenda item was initially presented or from a sub-meeting that was related to the meeting where the agenda item was initially presented may be organized with respect to the topic of the agenda item, so that a user can monitor the status of related meetings, including their outcomes if meetings have occurred or scheduled dates of meetings that have not yet been held.

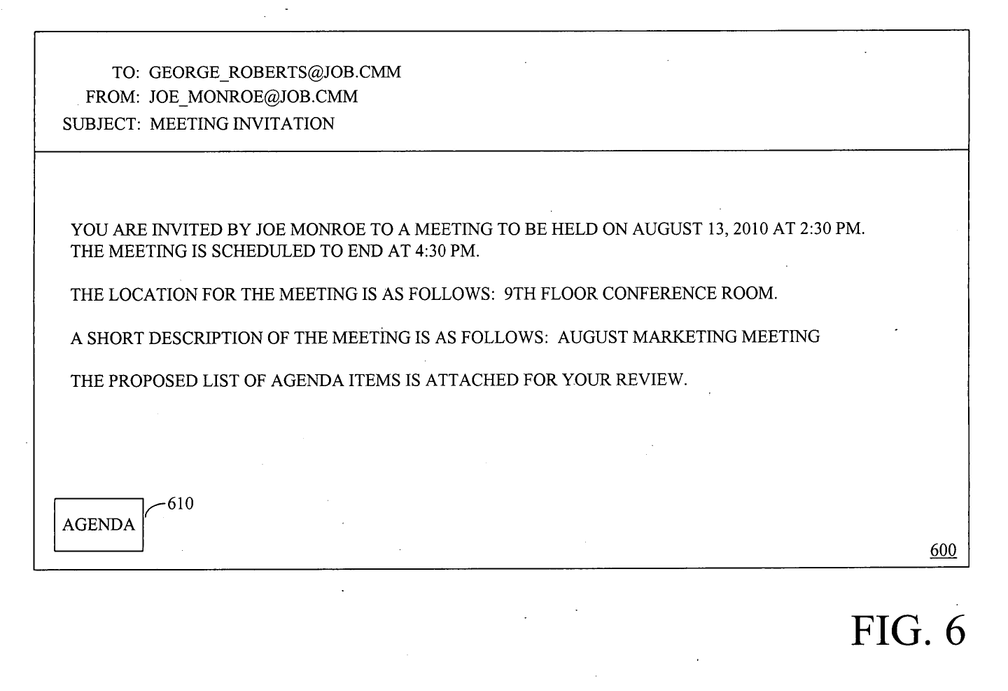

Referring now to FIG. 6, an example meeting invitation 600 is shown. In this example, the meeting invitation 600 is sent as an e-mail message to a person identified by the e-mail address, George_Roberts@job.cmm. The meeting invitation also identifies the sender of the message by the e-mail address, Joe_Monroe@job.cmm, and the subject of the invitation which is “Meeting Invitation.” Additional information is provided in the body of the invitation describing the proposed meeting and an attached file 610 is also included that describes the agenda for the proposed meeting. In some embodiments, a mechanism may also be provided in the invitation for automatically accepting or declining the meeting invitation.

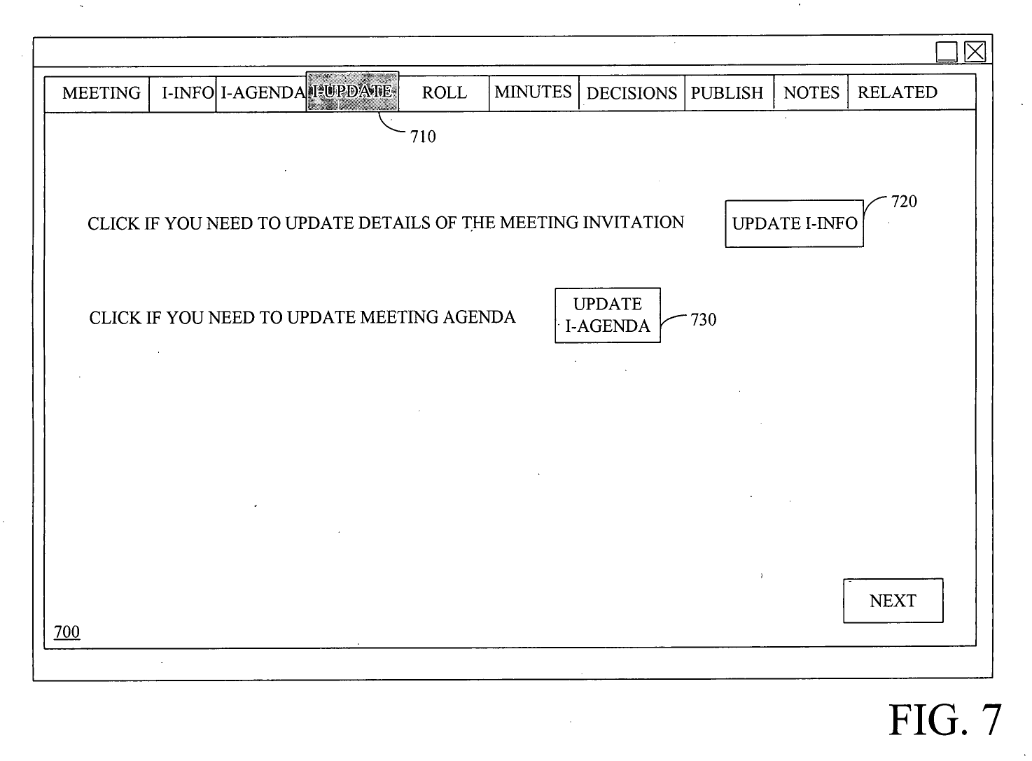

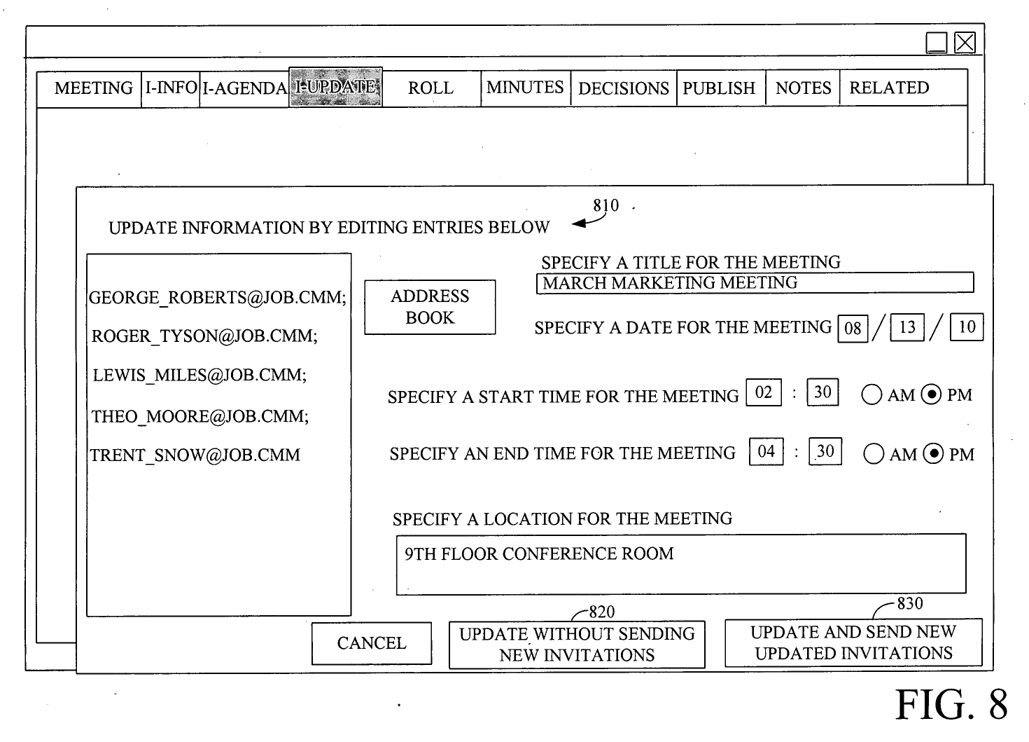

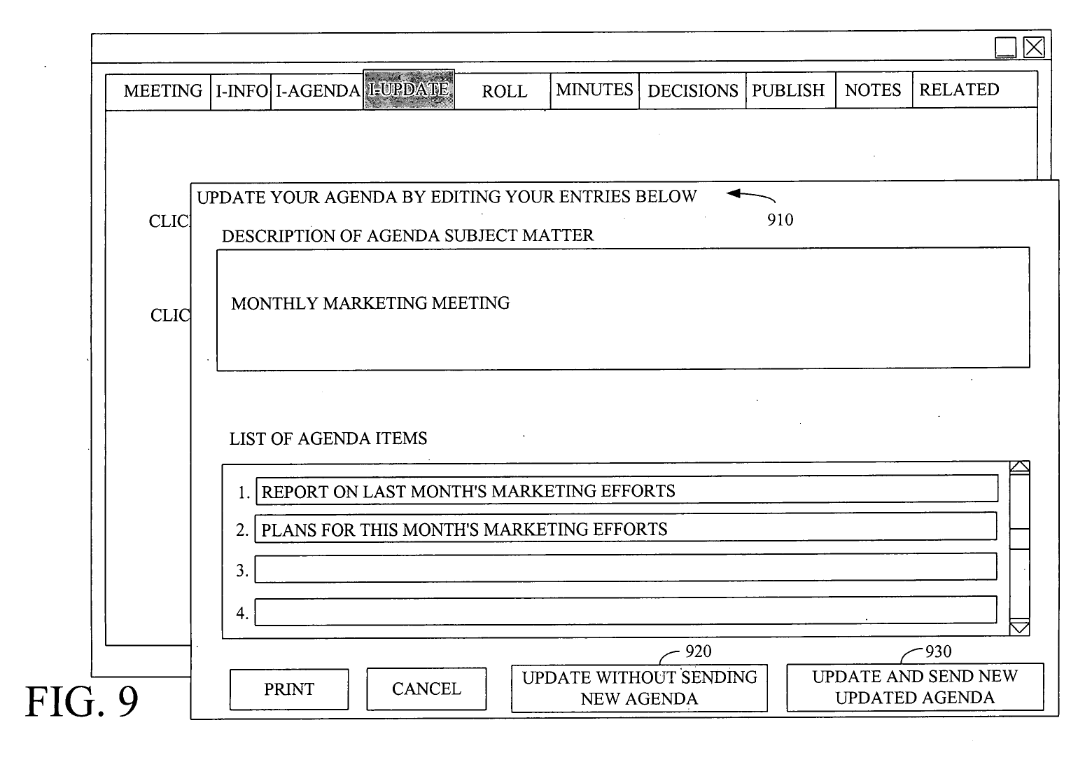

After meeting invitations are sent, a user can update or modify previously provided information by using the meeting manager interface screen 700 indicated by the highlighted UPDATE tab 710. For example, if a user previously typed in an incorrect e-mail address, the user can later correct the mistake by editing the invitee list. Therefore, in FIG. 7, if a user wants to edit information previously provided on the I-INFO interface screen 700, the user can select the UPDATE I-INFO button 720. Then, the user is presented the information that he or she previously provided, as shown in FIG. 8, and the user is prompted to edit the information (as noted by pointer 810). Correspondingly, if the user wants to edit information previously provided in the I-AGENDA screen, the user may select the UPDATE I-AGENDA button 730, as shown in FIG. 7. Then, the user is presented with a screen prompting the user to edit or change the information previously provided by the user, as shown in FIG. 9 and noted by pointer 910. After desired changes are made, the user is prompted to choose an option for updating the information. One option 820, 920 includes updating the information without sending new invitations, as shown in FIGS. 8 and 9, and another option 830, 930 includes updating the information and then sending out new meeting invitations.

After the date of the meeting passes and the meeting has been held, information previously provided by the user is then used to track and document what transpired at the meeting and events that are slated to occur as a result of the meeting. As such, the meeting manager 170 prompts the user to provide details about the meeting, such as the actual attendees. This information may be provided from a drop down list containing the persons that were invited to the meeting. In addition, persons not receiving an invite might have attended the meeting in place of someone who was not able to attend. As such, the meeting manager interface may provide a place for typing in identification information for persons not contained in the drop down list. Other types of information is also requested or offered to be recorded. For example, the issues discussed in the meeting may be provided along with associated information such as the resolution or status of the issue as it stood when the meeting closed. Also, reminders can be set for reminding the user to perform a follow-up action regarding the meeting, such as scheduling a new meeting, making a telephone call, sending out a follow-up report, etc.

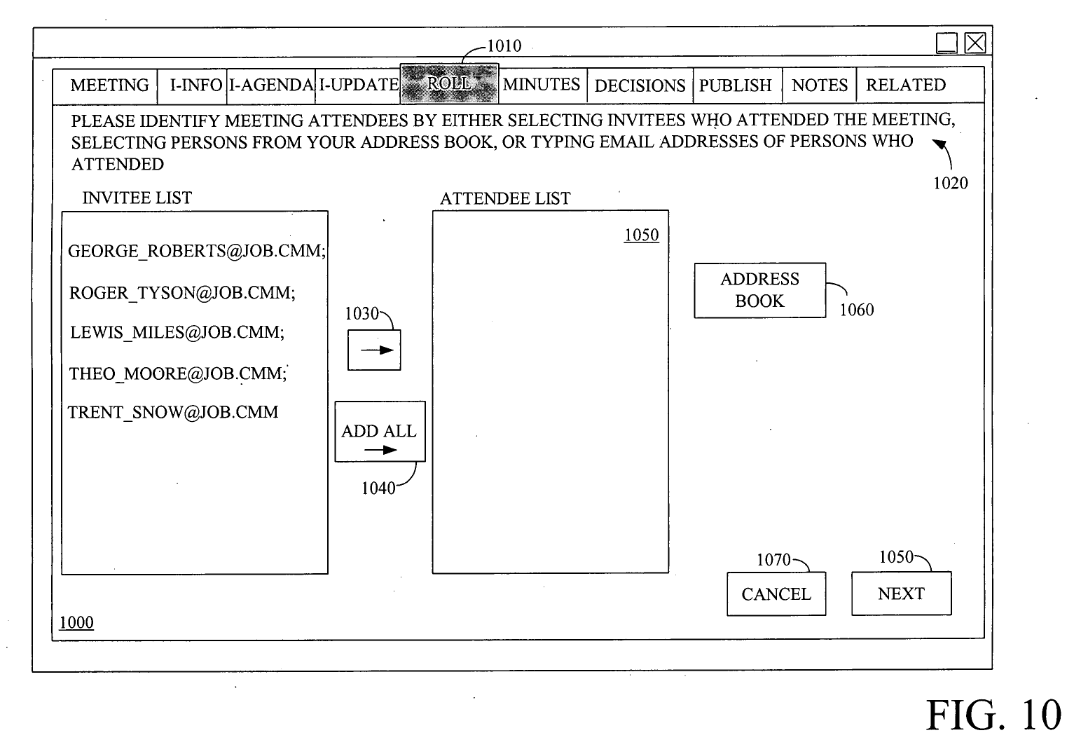

For example, a meeting manager interface 1000 indicated by the highlighted ROLL tab 1010, as shown in FIG. 10, prompts a user to identify persons who attended the meeting by allowing the user to select e-mail addresses of persons who were invited to the meeting initially (as noted by pointer 1020) where this information was saved as a collection of data. Accordingly, a user may select a name and then press the right arrow button 1030 to move the e-mail name to the list of attendees (“attendee list”). To move all of the e-mail names of the invitees to the attendee list, a user can simply select the ADD ALL button 1040. If a person attended the meeting who was not sent a message invitation (e.g., a person came in place of an invited person), the user can manually add an e-mail name of a person to the attendee list by typing the e-mail address in an input box 1050 or by selecting the address book button 1060 to select address(es) from an address book of a user. After a complete roll or list of the attendees is prepared, the user can move from the interface screen indicated by the ROLL tab 1010 to an additional interface screen by selecting the NEXT button 1050. Alternatively, to exit the interface screen without making any changes, the user can select the CANCEL button 1070.

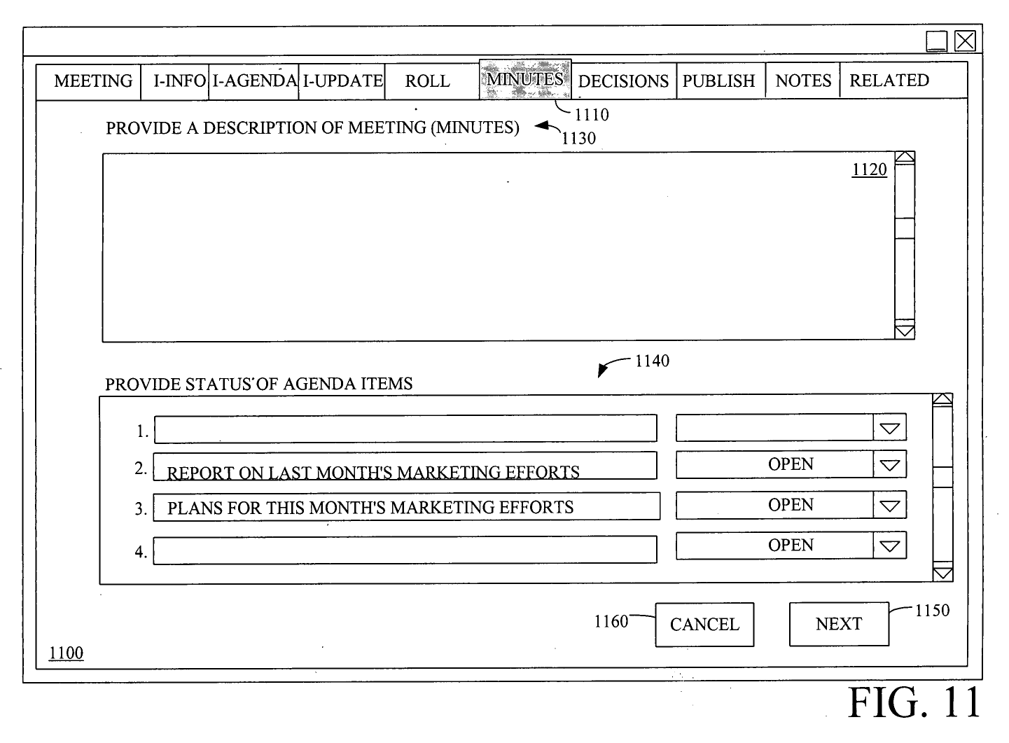

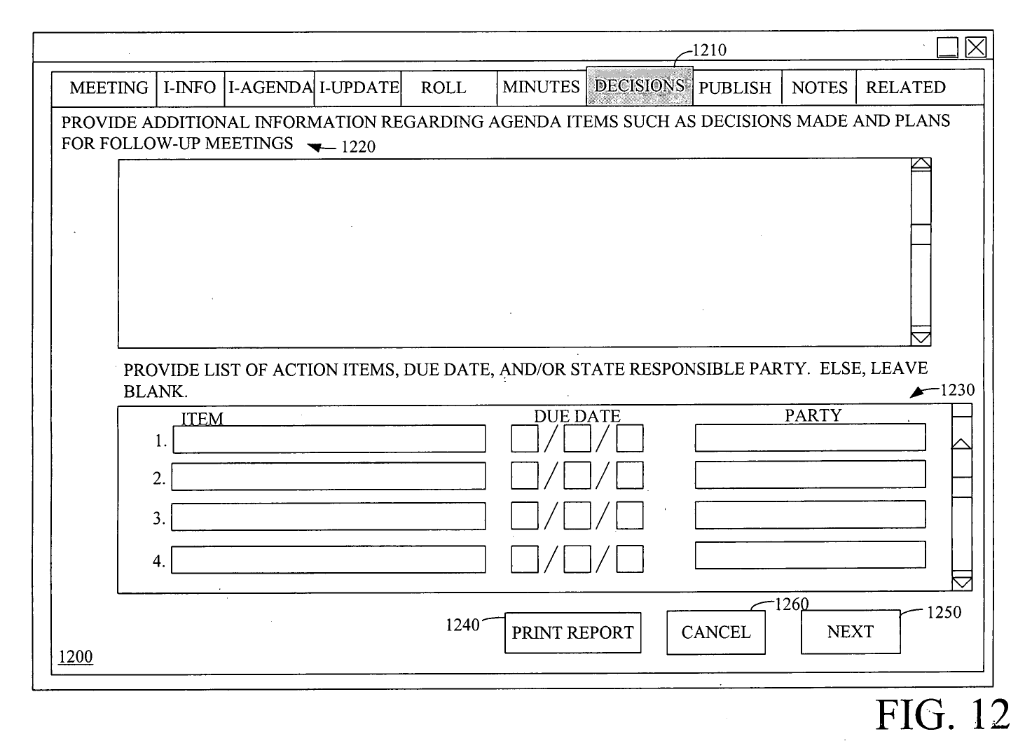

As shown in FIG. 11, the meeting manager interface screen 1100 indicated by the MINUTES tab 1110 may be used to provide a description of the happenings of the meeting. According to an exemplary embodiment, such a description or minutes is prepared and published to attendees or persons who were not able to attend so that a record is provided of meeting occurrences. As such, a interface screen 1100 prompts the user to provide a description of the meeting in a free form box 1120 (as noted by pointer 1130). Further, the user is prompted to provide the status of action items (that were previously provided by the user in creating an agenda for the meeting) at the close of the meeting (as noted by pointer 1140). To provide additional information, a user can progress to the interface screen 1200 (indicated by the DECISIONS tab 1210 in FIG. 12) by selecting the NEXT button 1150. Otherwise, to exit the meeting manager interface without making any changes, the user can select the CANCEL button 1160.

As shown in FIG. 12, a user is prompted (1220) to provide additional notes such as decisions reached in the meeting and/or plans for future events. Plus, action items that arose out of the meeting can be provided in the space provided 1230 and parties assigned to each action item may be supplied. To print a paper copy of the information provided in the MINUTES and DECISIONS screens 1100, 1200, the user can select the PRINT REPORT button 1240. In some embodiments, a formatted report for the meeting is printing. Also, by progressing to an additional interface screen 1300 indicated by the PUBLISH tab 1310 (by selecting the NEXT button 1250), the user is prompted to publish information describing the meeting to the attendees of the meeting. Otherwise, to exit the interface screen without making any changes, the user can select the CANCEL button 1260.

As mentioned previously, some embodiments enable a user to categorize whether an agenda item is expected to have additional information describing the agenda item after a meeting is held. Therefore, in some embodiments, an interface screen prompts a user to provide information for agenda items that have been categorized or marked as expecting additional information to be provided. For example, in some embodiments, a user may be provided a list of options for providing additional information, such as the option of designating a person assigned to handling an action item for the topic of the agenda item, specifying an action item that arose from presentation of the agenda item, providing a description of a decision that arose after presentation of the agenda item, providing information with regard to a new meeting that was planned in response to presentation of the agenda item, etc.

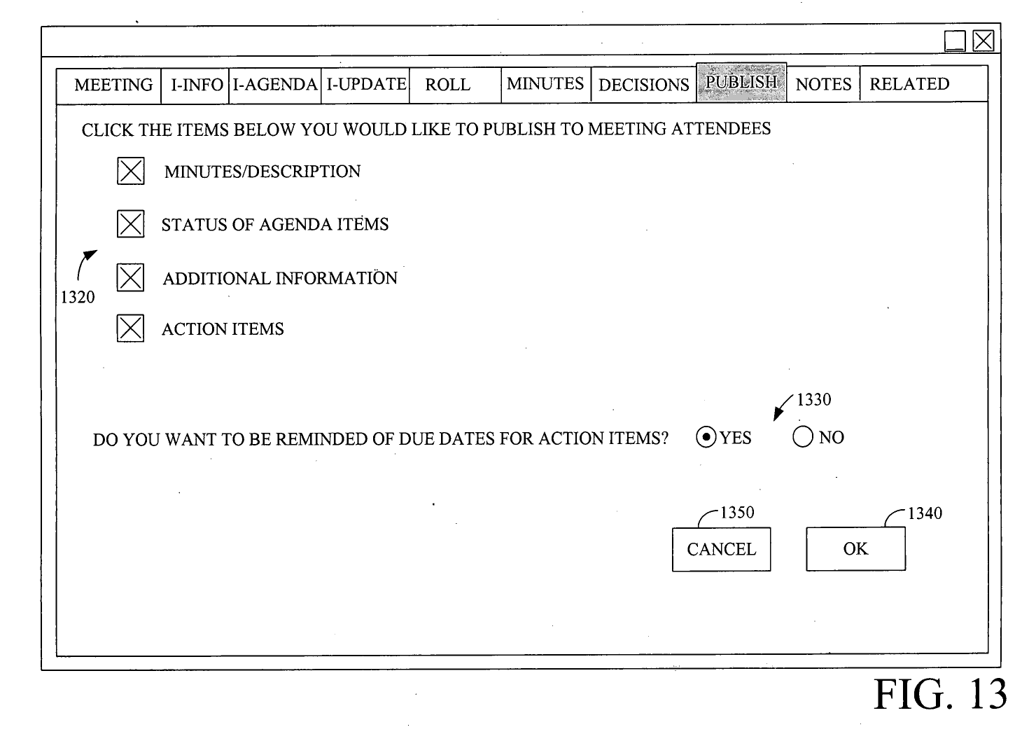

Referring to FIG. 13, a user can select what types of information that he or she would like to publish to the attendees by selecting check boxes 1320 next to a particular piece of information. Further, the user can choose to receive reminders about due dates for action items by selecting a radio button 1330 indicating YES or NO before selecting the OK 1340 button to send the selected meeting information to the e-mail addresses of persons who attended the meeting, as previously provided in an earlier session. Otherwise, to exit the meeting manager interface without making any changes, the user can select the CANCEL button 1350.

Note, to receive reminders of due dates for action items or other events, the meeting manager 170 may utilize an e-mail application 180 to send e-mail reminders. Alternatively, in some embodiments, the meeting manager 170 accesses a user's calendar to place the event on the user's calendar and to set up for calendar reminders of the due dates and may also access other software applications including file viewers, file editors, Web browsers, etc.

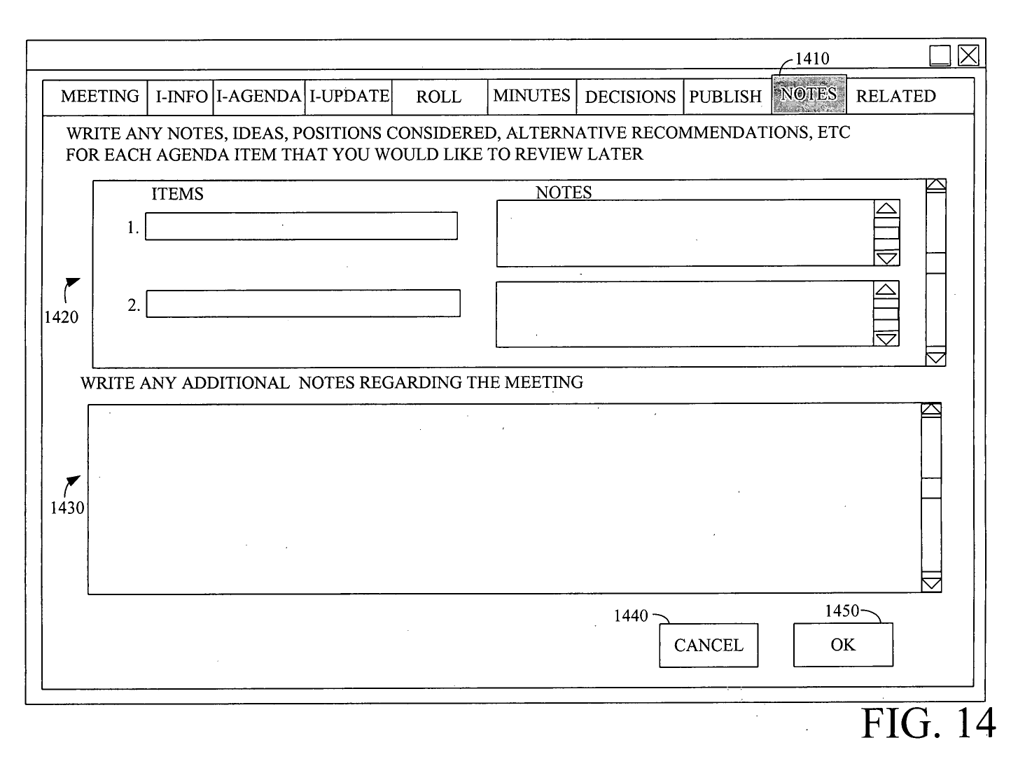

For extraneous information that the user may choose to document and record about the meeting, the meeting manager interface screen 1400 indicated by the NOTES tab 1410 provides the user additional spaces for documenting his or her thoughts, as shown in FIG. 14. For example, if an agenda item was being discussed and an interesting idea was mentioned with regard to that agenda item but the idea was not the ultimate decision reached for the item or was not germane to the format of a minutes report, the idea can be still be recorded within an interface screen 1400 of the meeting manager 170 (as noted by pointer 1420). Accordingly, an observation, alternative proposal, tangential thought, etc. that is not germane to an agenda item, may be typed down in the general space 1430 provided, also. To save and compile the information provided by the user, the OK button 1440 may be selected. Otherwise, to exit the interface screen without making any changes or saving any information, the user can select the CANCEL button 1450.

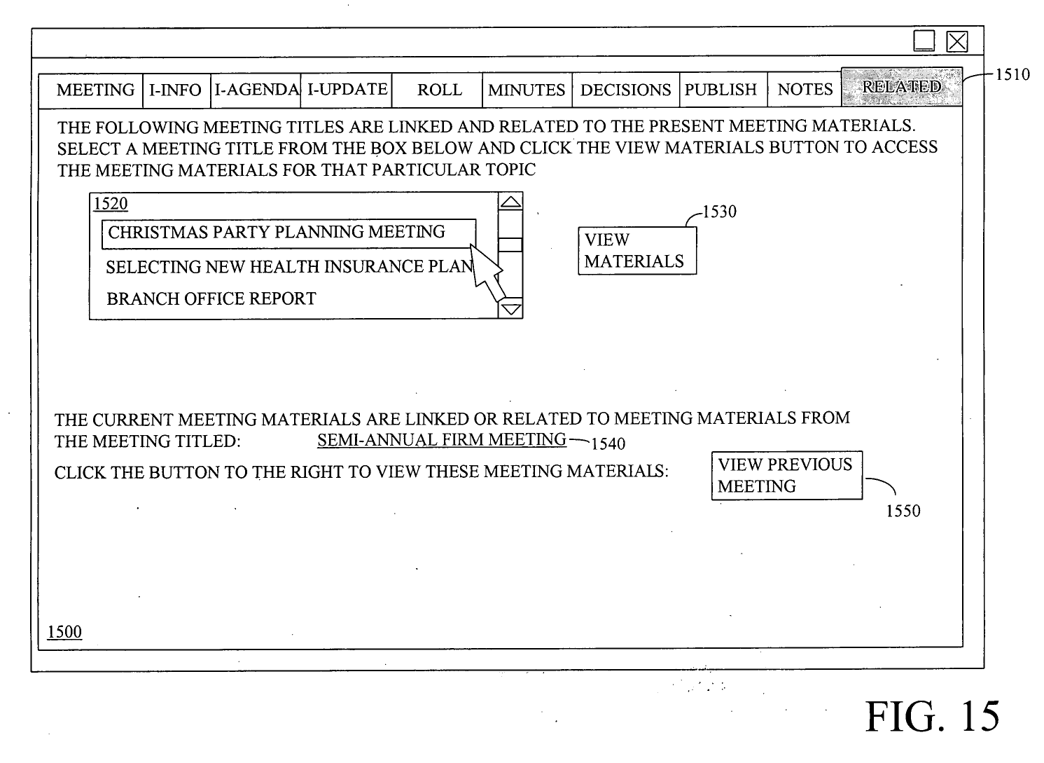

After a meeting has been planned, organized, held, and documented, the user can review meeting materials for different meetings that are linked and associated to the current or present meeting. For example, in the interface screen 1500 indicated by the RELATED tab 1510 in FIG. 15, an input box 1520 is provided to show meeting materials that have been linked to the present meeting materials.

As an example, assume a user creates meeting materials entitled “Yearly Meeting.” As such, the user creates meeting invitations for the “Yearly Meeting,” an agenda for the “Yearly Meeting,” and reports and notes for the “Yearly Meeting.” In the report, the user indicates that one of the results of the meeting is that another meeting is to be scheduled for planning a company Christmas party. Thus, when the meeting materials for scheduling the Christmas party is created, these meeting materials are linked to the meeting materials for the “Yearly Meeting.” In this way, the user can access the meeting materials for other meetings that arose out of or are related to the “Yearly Meeting.” In the example shown in the meeting manager interface of FIG. 15, if the user selects CHRISTMAS PARTY PLANNING MEETING and selects the VIEW MATERIALS button 1530, the data associated with the CHRISTMAS PARTY PLANNING MEETING populates the meeting manager interface 300 for the meeting manager 170.

Referring back to FIG. 15, an additional input option 1540 is also provided. With this option, a user can review meeting materials that resulted in or help generate the present meeting materials being viewed. As an example, assume that a user is viewing meeting materials for a meeting entitled “Yearly Meeting.” However, this meeting was the result or by-product of a previous meeting that was entitled “SEMI-ANNUAL FIRM MEETING.” Therefore, while viewing the meeting materials for the Yearly Meeting, a user can access the meeting materials for a previous meeting that is directly related to the present meeting materials. To do so, in the example provided in FIG. 15, the user can ascertain a meeting title that is provided as a textual string and select the VIEW PREVIOUS MEETING button 1550. Meeting material data associated with the selected meeting then populates the appropriate interface screens of the meeting manager 170.

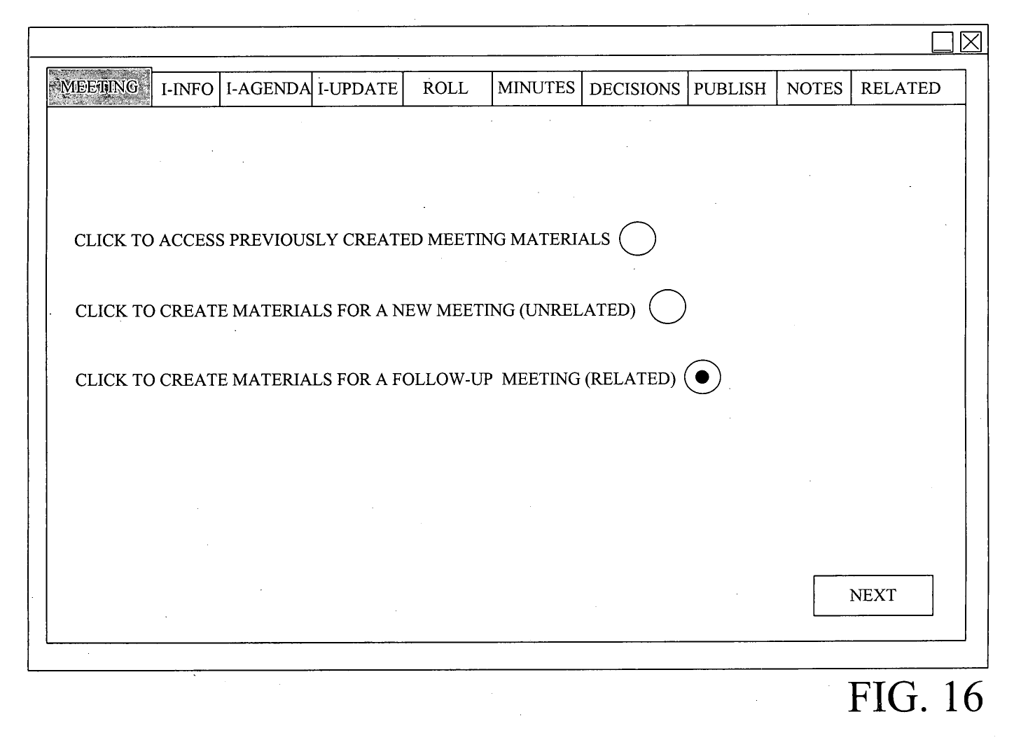

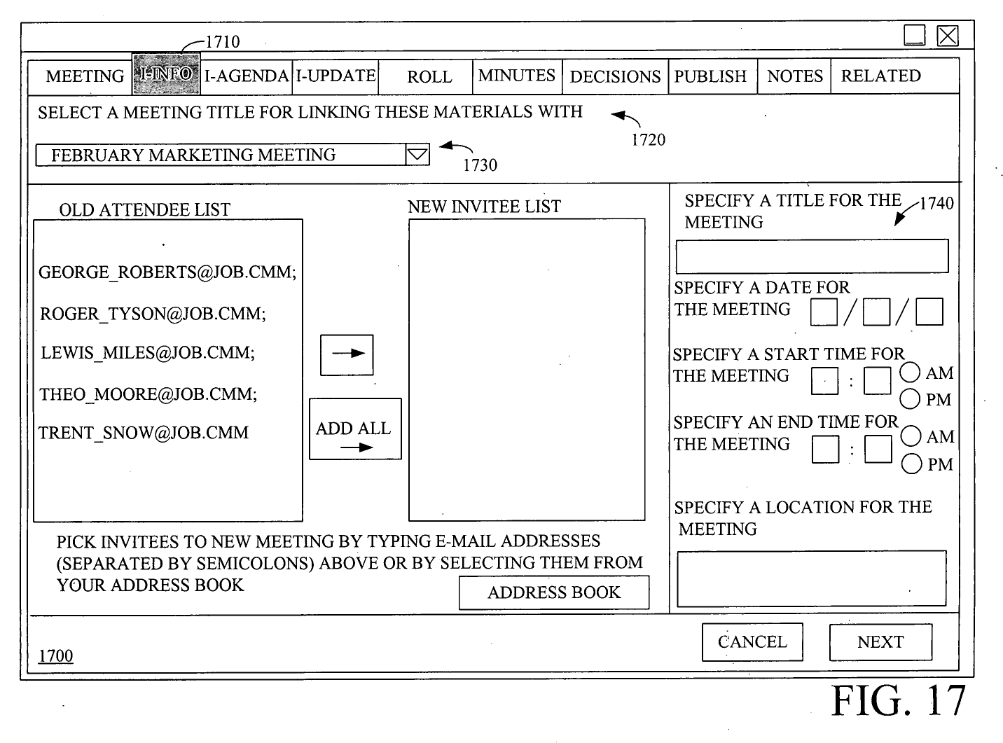

As previously mentioned from the onset with regard to FIG. 3, a user has three options 312-316, in some embodiments, for accessing or creating meeting materials. To create meeting materials that are going to be linked with previously created meeting materials (as previously discussed), a user can select the third option, as shown in FIG. 16. Then, the user is provided a different version of an interface screen 1700 indicated by the I-INFO tab 1710, as shown in FIG. 17. This version of the I-INFO screen 1700 contains a prompt for selecting a title of previously created meeting materials for linking with new meeting materials (as indicated by pointer 1720). In the example shown, the user has selected meeting materials entitled “FEBRUARY MARKETING MEETING” from a drop-down list of titles for previously created meeting materials (as indicated by pointer 1730). After selecting a title, the interface screen 1700 is then populated with data previously provided for the meeting materials of the selected title (e.g., FEBRUARY MARKETING MEETING). Accordingly, in some embodiments, the user can choose e-mail addresses of persons to invite to the new meeting from the e-mail addresses of persons who attended the earlier meeting. Further, the user is prompted to provide a date, a time, and a location for the meeting (as generally described previously and indicated by pointer 1740). Then, the user can plan and document meeting materials as was previously described.

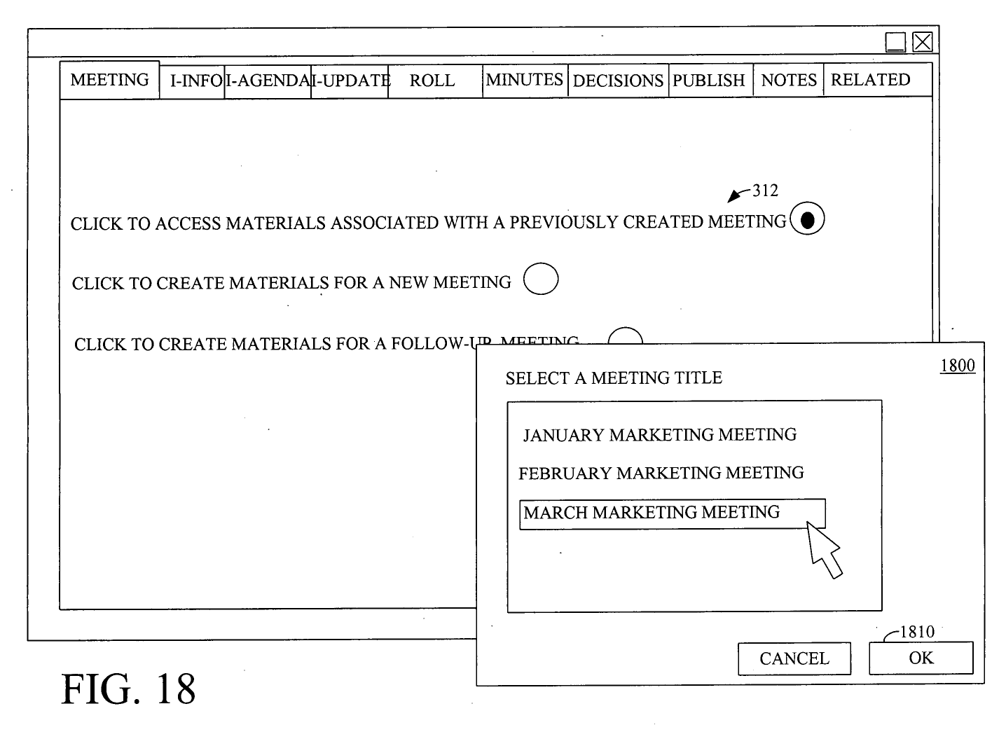

If a user simply would like to view previously created meeting materials, the user can select the first option as shown in FIG. 3 and demonstrated in FIG. 18. Accordingly, by selecting the radio button next to the first option 312 and selecting the NEXT button 340, in some embodiments, the user is presented with a pop-up window interface 1800 to select the meeting title of the meeting materials that the user would like to view. After selecting a title and activating the OK button 1810, the interface screen of the meeting manager 170 is then populated with meeting material information that had been previously saved. As such, the user can review meeting materials by navigating the different interface screens by using navigation buttons on the interface screens or by jumping from screen to screen by clicking on the tabs at the top of the interface screens. In this way, the meeting materials can provide historical tracking and becomes a log against a meeting topic. In some embodiments, to prevent meeting material information from being changed or lost, the meeting manager 170 may present the information in a read-only mode.

Accordingly, in some embodiments, meeting materials maintained in the database on the local storage device 167 may be made available to other users in a read-only basis. Therefore, in some embodiments, a person could track meeting materials that arose from meetings that the person attended and meeting materials that arose from meetings related to the meeting that the person attended. Further, a person could monitor meetings that are scheduled to be held that are related to a previous meeting that the person has attended. In this way, a person could request to be added to the invitee list for a meeting that is related to a previous meeting attended by the person, where the person was not included on the invitee list. Further, in some embodiments, a person may be allowed to automatically add himself or herself to the invitee list.

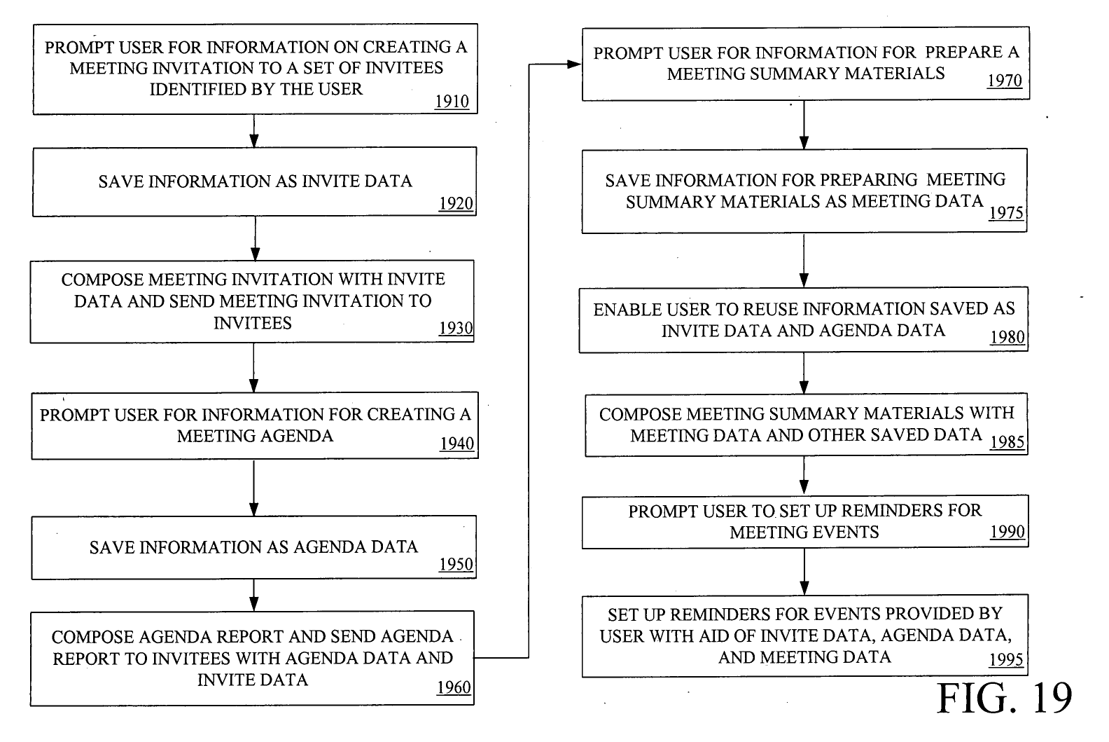

In accordance with one embodiment, among others, of the present disclosure, FIG. 19 illustrates a process for preparing meeting materials from setting a meeting time to having the meeting and further to setting up a follow-up meeting. As shown in FIG. 19, a user is prompted (1910) to provide information for creating a meeting invitation to a set of invitees identified by the user. The information provided may include a date for the meeting, a time for the meeting, a location for the meeting, details about the purpose or subject matter of the meeting; instructions for confirming attendance at the meeting, list of persons (and their communication addresses) for inviting to the meeting, etc. Further, to help the user to provide this information, assistance aids may electronically be provided to the user, such as a calendar showing possible meeting dates or a calendar showing the availability of the user and possibly the persons being invited to the meeting; an address book for providing communication addresses to which the meeting invitation may be sent; a text editor for creating an agenda report that may be included with the invitation; etc.

The information provided by the user for creating the message invitation is saved (1920) as data on a computer system and may generally be referred to as a collection of “invite data.” Then, a meeting invitation is composed with the invite data and copies of the meeting invitation are sent (1930) to persons identified as invitees. Additionally, a user is prompted (1940) for information to be used in creating a meeting agenda. The information provided by the user is then saved (1950) as data on a computer system and may generally be referred to as a collection of “agenda data.” Next, an agenda report is composed with the agenda data and the invite data and sent (1960) to the meeting invitees.

Also as part of the process, the user is prompted (1970) to provide information for preparing meeting summary materials. The information provided by the user is then saved (1975) as data on a computer system and may generally be referred to as a collection of “meeting data.” Further, previously provided information, such as the invite data and the agenda data, is enabled (1980) to be reused in preparing the meeting summary materials. Thus, the meeting summary materials are composed (1985) with the meeting data and other saved data, such as invite data and agenda data. Further, as part of the process, the user is prompted (1990) to set up reminders for meeting events. Reminders are then set up (1995) by the user with the assistance of information provided by the invite data, agenda data, and meeting data.

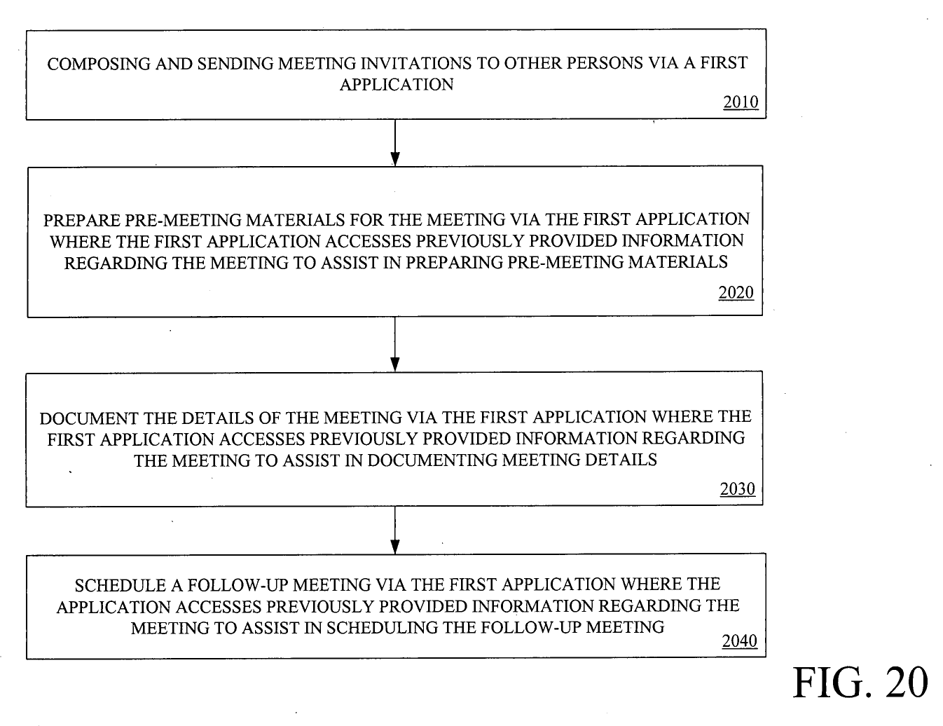

Next, FIG. 20 illustrates another embodiment of a process, among others, for preparing meeting materials in accordance with the system of FIG. 1. In FIG. 20, an initial step involves composing and sending (2010) meeting invitations to other persons via an application configured to composed and send invitations which may generally be referred to as a first application. For example, by using a first application, a user can create invitations for a meeting and send the invitations to other persons. The invitations may describe a time and place for the meeting and provide a general description of the meeting. Then, the user can direct the first application to prepare (2020) pre-meeting materials, such as an organizational outline for the meeting that can be followed during the actual meeting. Information previously provided by the user is used by the first application to assist in preparing pre-meeting materials. For example, information provided by the user to create the meeting invitations may be used to assist in creating pre-meeting materials. To document (2030) the details of the meeting after it is held, the first application accesses previously provided information regarding the meeting (such as that provided to create meeting invitations and/or pre-meeting materials) to facilitate preparation of the meeting detail documents by the user via the first application. Further, to schedule (2040) a follow-up meeting (or other post-meeting materials), the first application accesses previously provided information regarding the meeting (such as that provided to create meeting invitations, pre-meeting materials, and/or meeting documentation) to assist in setting up and scheduling the follow-up meeting (or preparing other post-meeting materials) by the user via the first application.

As a result, if a new meeting needs to be scheduled to discuss issues that were left unresolved from a previous meeting or other issues associated with subject matter of a previous meeting, meeting invites can be created in a similar manner as before. To select persons to receive the new meeting invite, a drop down list may be provided (via the first application) containing the persons who attended the meeting and/or the persons who receive invitations to a previous meeting. Each step in the process leads to another logical step in the sequence, however all of the steps do not need to be completed at one time.

In addition, a user can update the status of issues pertaining to meeting subject matter. The first time that a follow-up on meeting issues is activated, the issues identified in the meeting may be provided in one embodiment of an interface to the first application. Accordingly, in subsequent accesses to the follow-up interface, the issues that were previously presented are re-presented to the user. In addition, a user can create new issues that are being considered and/or can update the status of previous issues. In the process shown, in addition to steps for managing the establishment of a time and place for a meeting, steps are also provided for managing the meeting itself.

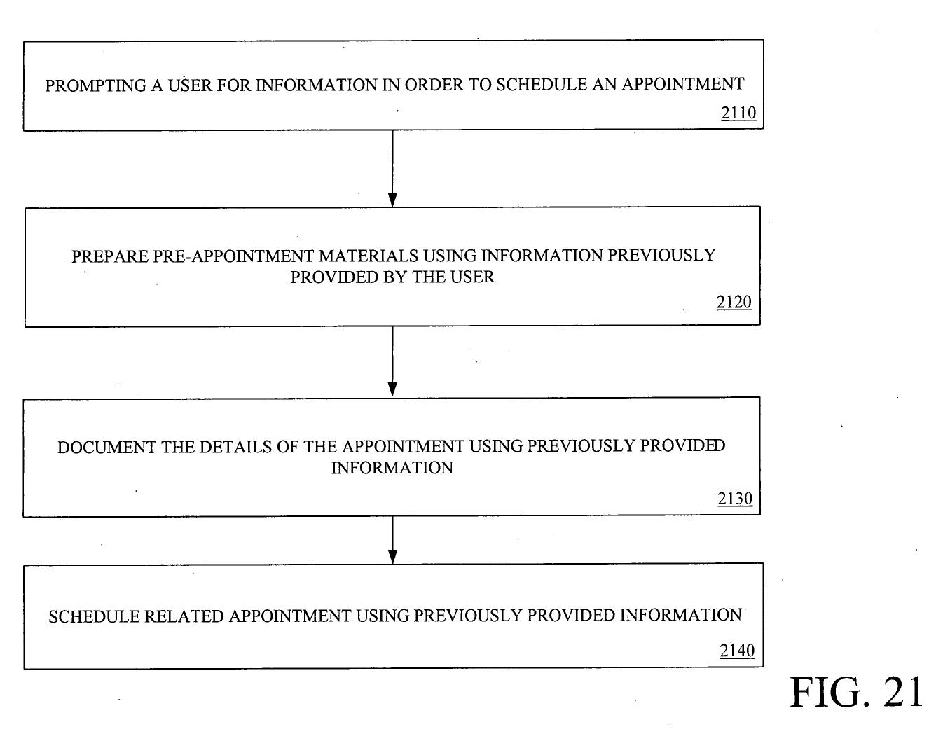

In accordance with the present disclosure, one embodiment, among others, encompasses preparing materials for a scheduled event, in general, such as an appointment. For example, FIG. 21 illustrates such a process. In FIG. 21, an initial step involves prompting (2110) a user for information in order to schedule an appointment, such as a date, time, and subject of the appointment, via a computer application. The information is saved as data on a computer system and may generally be referred to as a collection of “appointment data.” Then, the user can direct the computer application to prepare (2120) pre-appointment materials, such as a checklist of items that are desired to be performed before the appointment occurs and/or desired to be performed during the appointment. For example, a user may assign himself or herself actions in advance of the appointment, which would act as a task checklist against the event (e.g., an appointment). Information previously provided by the user is used by the computer application to assist in preparing pre-appointment materials. For example, information provided by the user to create and schedule the appointment may be used to assist in creating pre-appointment materials. To document (2130) the details of or notes from the appointment after it is held, the computer application accesses previously provided information regarding the appointment to facilitate preparation of information describing the appointment by the user via the computer application. Further, to schedule (2140) another related appointment, the computer application accesses previously provided information regarding the subject of the appointment to assist in setting up and scheduling another appointment by the user via the computer application.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure.

Therefore, having thus described the disclosure, at least the following is claimed:

1. A system for preparing and organizing event materials, comprising:
first logic configured to:
prompt a user to provide a first set of information;
utilize the first set of information to prepare a first set of event materials for an event, the first set of event materials including event invitations for the event;
electronically send the event invitations;
prompt the user to provide a second set of information;
utilize the first set of information and the second set of information to prepare a second set of event materials for administering the event;
prompt the user to provide a third set of information; and
utilize the first set of information, the second set of information, and the third set of information to prepare a third set of event materials which documents outcomes from the event; and
second logic configured to associate materials prepared for the event with materials prepared for a related event.

2. The system of claim 1, wherein the first set of information includes contact information for event invitees, the second set of information includes an event agenda, and the third set of information includes an action item list for the event, the event comprising a meeting.

3. The system of claim 2, wherein the third set of information identifies persons that attended the event.

4. The system of claim 2, wherein the third set of information includes minutes for the event, the event comprising a meeting.

5. The system of claim 1, the first logic further configured to:
prompt the user to provide a fourth set of information; and
utilizing the first set of information, the second set of information, the third set of information, and the fourth set of information to schedule a follow-up event to the event.

6. The system of claim 1, the second logic further configured to:
display event materials for the event, the event materials including the first set, second set, and third set of event materials, and event materials for a related event.

7. The system of claim 1, wherein the first logic is configured to update event materials with a fourth set of information provided by the user.

8. A method for preparing and organizing event materials, comprising the steps of:
prompting a user to provide a first set of information for an event;
utilizing the first set of information to prepare a first set of event materials for scheduling the event, the first set of event materials including event invitations for the event;
electronically sending the event invitations;
prompting the user to provide a second set of information;
utilizing the first set of information and the second set of information to prepare a second set of event materials for administering the event;
prompting the user to provide a third set of information; and
utilizing the first set of information, the second set of information, and the third set of information to prepare a third set of event materials for documenting the event.

9. The method of claim 8, wherein the second set of event materials include an organizational outline for the event that can be followed during the event.

10. The method of claim 8, further comprising the step of:
utilizing the first set, second set, and third set of information to assist in scheduling a follow-up event.

11. The method of claim 8, wherein the first set of information includes a planned agenda for the event.

12. The method of claim 8, further comprising the steps of:
prompting the user to provide a fourth set of information; and
utilizing the first set of information, the second set of information, the third set of information, and the fourth set of information to prepare a fourth set of event materials for scheduling a follow-up event.

13. The method of claim 12, wherein the third set of information identifies persons that attended the event and fourth set of event materials includes event invitations that are sent to the persons that attended the event, as identified in the third set of information.

14. The method of claim 12, further comprising the steps of:
prompting a user for a fifth set of information; and
utilizing the fifth set of information to update previously provided event materials.

15. The method of claim 12, further comprising the step of:
linking the event materials for the follow-up event with the event materials for the event in a database; and
providing an interface for accessing information stored in the database, where the interface enables a user to select event materials for viewing with regard to the event, the viewed event materials including event materials for the follow-up event that is related to the event.

16. A computer readable medium having a computer program for preparing and organizing event materials, the program including instructions for performing the steps of:
prompting a user to provide a first set of information for a event;
utilizing the first set of information to prepare a first set of event materials for scheduling the event, the first set of event materials including event invitations for the event;
electronically sending the event invitations;
prompting the user to provide a second set of information;
utilizing the first set of information and the second set of information to prepare a second set of event materials for administering the event;
prompting the user to provide a third set of information; and
utilizing the first set of information, the second set of information, and the third set of information to prepare a third set of event materials which documents outcomes from the event.

17. The medium of claim 16, wherein the first set of information includes a planned agenda for the event and the second set of event materials include an organizational outline for the event that can be followed during the event,

18. The medium of claim 16, wherein the program further includes instructions for performing the steps of:
prompting the user to provide a fourth set of information; and
utilizing the first set of information, the second set of information, the third set of information, and the fourth set of information to prepare a fourth set of event materials for scheduling a follow-up event, wherein the third set of information identifies persons that attended the event and fourth set of event materials includes event invitations that are sent to the persons that attended the event, as identified in the third set of information.

19. The medium of claim 18, wherein the program further includes instructions for performing the steps of:
prompting a user for a fifth set of information; and
utilizing the fifth set of information to update previously provided event materials.

20. The medium of claim 19, wherein the program further includes instructions for performing the steps of:
linking the event materials for the follow-up event with the event materials for the event in a database; and
providing an interface for accessing information stored in the database, where the interface enables a user to select event materials for viewing with regard to the vent, the viewed event materials including event materials for the follow-up event that is related to the event.
